(19) United States
(12) Patent Application Publication
(10) Pub. No.: US 2008/0086400 A1
(43) Pub. Date: Apr. 10, 2008

(54) COMPUTERIZED CREDIT SERVICES INFORMATION MANAGEMENT SYSTEM

(76) Inventors: Carrie Ardelean, Dallas, TX (US); Douglas Van Arsdale, Frisco, TX (US); Cody Wray, Arlington, TX (US)

Correspondence Address: HOWISON & ARNOTT, L.L.P, P.O. BOX 741715, DALLAS, TX, 75374-1715, US

(21) Appl. No.: 11/532,405

(22) Filed: Sep. 15, 2006

(51) Int. Cl. G06Q 40/00; G07F 19/00; G07B 17/00

(52) U.S. Cl. 705/35; 705/30

(57) ABSTRACT

A method of processing online applications is disclosed. The method includes receiving a customer contact lead, contacting the customer to obtain application data, preparing an application using the application data, and delivering the application to the customer. An electronic signature is accepted for completion of the application.

### TECHNICAL FIELD OF THE INVENTION

This application relates to debt settlement generally and, more specifically, to a network based debt settlement management system.

### BACKGROUND OF THE INVENTION

Consumer credit has become a mainstay of American life and the American economy. With consumer loans, both fixed term and revolving, people of all classes can afford to purchase large ticket items and use them immediately. This is in contrast with practices of generations past where a person or family was typically required to do without the desired item until sufficient capital to pay for the item outright was available. Notwithstanding commentary concerning the long term risks to the economy and an aging population, other problems exist within the modern credit market.

A typical consumer is at an informational disadvantage at every stage of dealing with a creditor. Although federal regulations exist to specify requisite disclosure on credit applications, even these can be difficult to understand. Particular circumstances and events make it all the more difficult to discern a good offer of credit from a poor one. For example, many consumers may be forced to deal with issues of credit when in the high pressure atmosphere of an automobile showroom or when an appliance needs immediate replacement or expensive repairs. These and other such problems lead many consumers to be overwhelmed by consumer debt. Even with responsible debt management, volatility in the job market can easily leave one overextended.

A consumer who is overly pressured by debt, or unable to pay the required payments at all, continues to face informational disadvantage and is often unaware of ways to obtain respite that may be available. In fact, a variety of ways that the consumer may have access to assistance and information exist. The proliferation of Internet access and personal computers in the home means that even a family in financial difficulty is likely to have Internet access.

What is needed is a system and method of addressing the above, and related, issues.

### SUMMARY OF THE INVENTION

The present invention disclosed and claimed herein, in one aspect thereof, comprises a method of processing online applications. The method includes receiving a customer contact lead, contacting the customer to obtain application data, preparing an application using the application data, and delivering the application to the customer. An electronic signature is accepted for completion of the application.

The present invention disclosed and claimed herein, in another aspect thereof, comprises a method of processing online applications. The method includes serving a customer a webpage including an application form, receiving the completed application form, storing the completed application contents in a database, preparing an enrollment packet, and providing the enrollment packet to the customer.

The present invention disclosed and claimed herein, in another aspect thereof, comprises a system for receiving and processing online applications. The system includes a relational database adapted to retain customer and creditor contact information and credit account information, a web server adapted to receive customer information and store the information in the relational database, and an Internet connection for communicating with a customer computer for receiving the customer information. The web server provides an enrollment webpage to a customer based upon a predetermined format, allowing the customer to provide customer data and credit account information to the web server. The web server is configured to accept an electronic signature from the customer for the establishment of a representative relationship between the customer and a debt settlement agency.

### BRIEF DESCRIPTION OF THE DRAWINGS

For a more complete understanding of the present invention and the advantages thereof, reference is now made to the following description taken in conjunction with the accompanying drawings in which:

FIG. 1 is a relational diagram illustrating the relationship between a debtor, a creditor, and a debt settlement agency.

FIG. 2 is a system diagram illustrating one embodiment of an operating environment for a debt settlement agency according to aspects of the present disclosure.

FIG. 3 is a block diagram of one embodiment of a departmental division of a debt settlement agency according to aspects of the present disclosure.

FIG. 4 is a flow diagram illustrating one embodiment of a method of processing client contacts according to aspects of the present disclosure.

FIG. 5 is a flow diagram illustrating one embodiment of an incoming communications process for a debt settlement agency according to aspects of the present disclosure.

FIG. 6 is a flow diagram illustrating one embodiment of a method for enrolling and servicing debt settlement client according to aspects of the present disclosure.

FIG. 7 is a system diagram illustrating one embodiment of a web server providing an enrollment page according to aspects of the present disclosure.

FIG. 8 is a flow diagram corresponding to one method of presenting a webpage according to aspects of the present disclosure.

### DETAILED DESCRIPTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

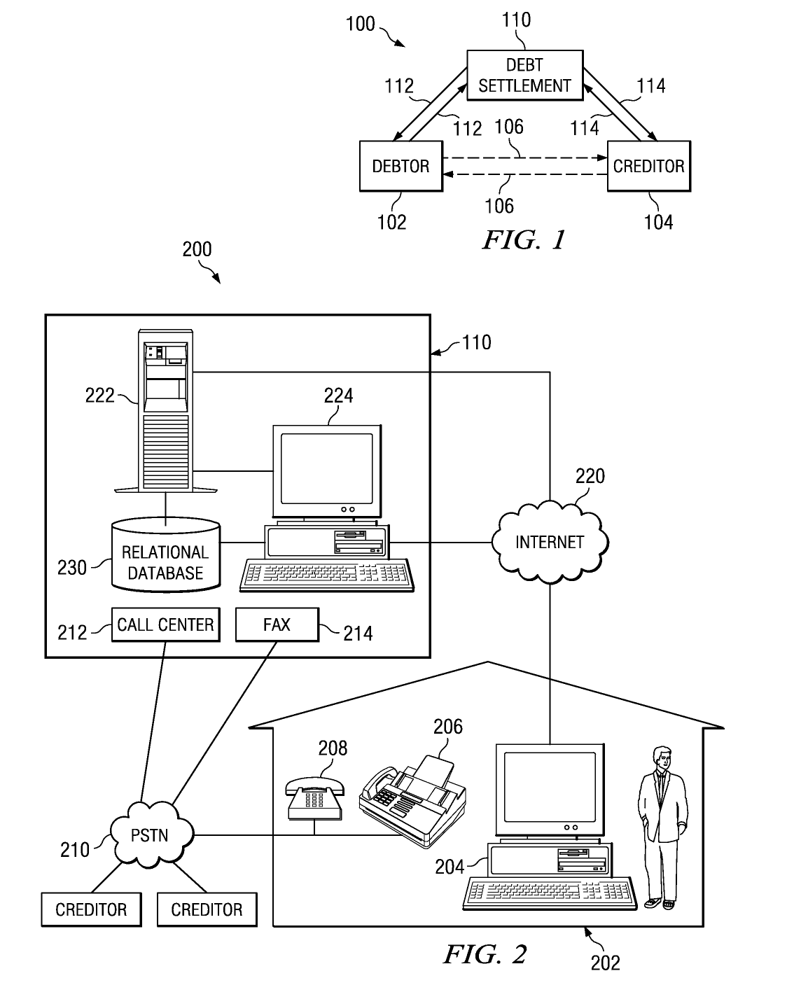

Referring now to FIG. 1, a relational diagram illustrating the relationship between a debtor, a creditor and, a debt settlement agency is shown. The debtor 102 may be an individual, a corporation, a partnership, or another entity capable of assuming a debt or entering into a loan transaction. The creditor 104 may be a bank, a credit union, a credit card company or another institution issuing loans or credit. Typically, the initial debtor/creditor relationship will be established between a single debtor 102 and a single creditor 104. Correspondences and transactions between the debtor 102 and the creditor 104 are shown in FIG. 1 by the arrows 106. In some cases, the relationship between the debtor 102 and the creditor 104 may become strained or even hostile. This may be because the debtor 102 feels as if they are being treated unfairly by the creditor 104, or possibly because the debtor 102 is insolvent, bankrupt, or otherwise unable to fulfill the obligations between the debtor 102 and the creditor 104. In such cases, the debtor 102, or possibly the creditor 104, may engage the services of a debt settlement agency 110.

Typically, the debt settlement agency 110 will be skilled at negotiating a compromise between the debtor 102 and the creditor 104. The compromise may involve an adjusted payment plan or a reduction in the amount repaid. Sometimes the bargain will be in exchange for having the reduced amount paid to the creditor 104 immediately. In some embodiments, the debt settlement agency 110 may have previously negotiated with a particular creditor 104 on behalf other debtors and may therefore be skilled in dealing with the creditor 104 again. In some embodiments, the debt settlement agency 110 may present an alternative for the debtor 102 to bankruptcy, credit counseling or continued insolvency or inability to pay. Moreover, this may be an alternative way for the debtor 102 to avoid foreclosures, seizures and other negative consequences of being unable to service existing debt.

In the embodiment shown in FIG. 1, a single debtor 102, a single creditor 104, and a single debt settlement agency 110 are shown. However, the present description and disclosure is not meant to be so limited. For example, a single debtor 102 may have multiple creditors, such as creditor 104. It is possible that the debtor 102 would be dealing with all of these creditors through the single debt settlement agency 110. As can be seen in FIG. 1, when the debt settlement agency 110 is engaged, the debtor 102 typically begins conferring, communicating, and exchanging documents with the debt settlement agency 110, as shown by the arrows 112. Correspondingly, when the debt settlement agency 110 is acting on behalf of the debtor 102, the debt settlement agency will correspond and communicate with the creditor 104, as shown by the arrows 114. Thus, the communications and correspondences shown by the arrows 112 and 114 may take the place of the communications shown by the arrows 106, which represent the typical communications and correspondence between the debtor 102 and creditor 104.

Referring now to FIG. 2, a system diagram 200 illustrating one embodiment of an operating environment for a debt settlement agency 110 according to aspects of the present disclosure is shown. FIG. 2 is meant to represent a more detailed environment and operating structure for the debtor 102, the creditor 104 and the debt settlement agency 110 as originally shown in FIG. 1. In FIG. 2, the debtor 102 is shown occupying a residence 202, although the debtor 102 does not necessarily have to communicate and interact with the system from a residence. For example, an office setting may be used to gain access to the necessary equipment, as will be described herein. This is particularly so when the debtor 102 may be a business. In one embodiment the residence 202 will be a home office and may contain a personal computer 204, a fax machine 206, and a telephone 208. The personal computer 204 may be a work station, laptop, or another device capable of accessing the Internet. The fax machine 206 and telephone 208 may be a standard fax machine and telephone, respectively. Such devices may communicate via a public switched telephone network (PSTN) 210. In other embodiments, the fax machine 206 and/or the telephone 208 may be packet-based devices that may communicate over the Internet 220. In the embodiment shown, the debtor 102 may communicate with the debt settlement agency 110 via the telephone 208 through the PSTN 210 and/or using the personal computer 204 through the Internet 220.

The debt settlement agency 110 may comprise one or more different physical locations or buildings. As shown in FIG. 2, various equipment and settings may be needed to fulfill all of the functions of the debt settlement agency 110. The debt settlement agency 110 may have a call center 212 that functions to field incoming calls from the debtor 102 and/or one or more creditors 104. The call center 212 may be partially automated and may also be staffed with a number of live personnel. The fax center 214 may comprise one or more fax machines for receiving facsimile communications from the debtor 102. As with the debtor 102, the debt settlement agency 110 may have a call center 212 and/or fax facility 214 that communicates through the PSTN 210 or, alternately, is packet-based and operates over the Internet. Both the call center 212 and the fax facility 214 may have multiple lines and/or operators available and will therefore be able to able to service multiple debtors simultaneously. Similarly, it may be possible for the debt settlement agency 110 to engage in communications with multiple creditors 104 simultaneously.

The debt settlement agency 110 may also have one or more computer terminals 224 implementing part of the functionality and automation needed by the debt settlement agency 110. Although, only a single computer 224 is shown, it is understood that the debt settlement agency 110 may use many such computer terminals 224. In one embodiment, debt settlement specialists and other employees of the debt settlement agency 110 may each have access a computer terminal 224. The computer terminal 224 may be connected to a local network (not shown) and/or the Internet 220. The computer terminal 224 may be a personal computer or a purpose-built machine or terminal for use by the debt settlement agency employees. A web server 222 is also provided and connected to the Internet 220 and possibly to the computer terminal 224. As will be described in greater detail below, the debt settlement agency 110 can make use of the web server 222 to automate part of the functionality provided to the debtors 102 and the creditors 104 by the debt settlement agency 110. A relational database 230 may also be provided and connected to the web server 222 and/or the computer terminal 224. The relational database 230 may be an Oracle® database from the Oracle Corporation of Redwood Shores, California, an Access® database from Microsoft Corporation of Redmond, Wash. or another commercially available database product. The database 230 could also be custom-made for the debt settlement agency 110. The relational database 230 serves as a repository for customer or debtor 102 contact information, as well as creditor 104 contact information. The relational database 230 may be implemented on a single computer or a series of computers.

It can be seen from FIG. 2 that the debtor 102, the creditors 104 and the debt settlement agency 110 may communicate via the Internet 220 or via the telephone network 210. Although not explicitly shown in FIG. 2, the creditors 104 may also communicate with the debt settlement agency 110 via the Internet. Additionally, other means of communication, such as delivery or courier services, or the U.S. mail, may be used if necessary to exchange information between the parties shown in FIG. 2.

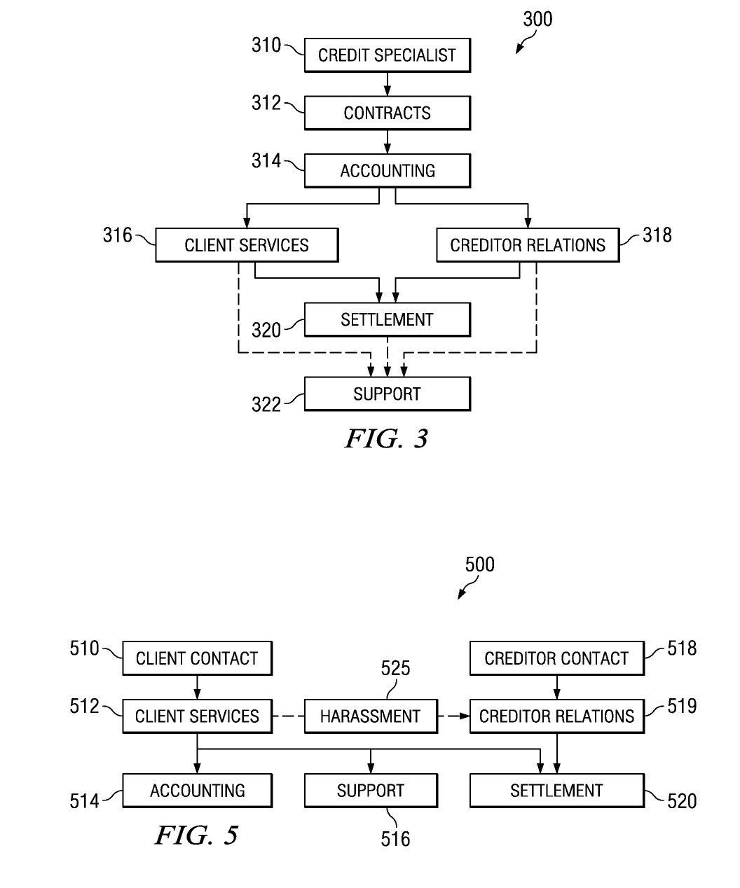

Referring now to FIG. 3, block diagram 300 of one embodiment of a departmental division of a debt settlement agency according to aspects of the present disclosure is shown. A credit specialist 310 is shown as reporting to a contract department 310. In FIG. 3, a single credit specialist 310 is shown, but it is understood that there may be many credit specialists. As will be described in greater detail below, the credit specialist 310 may serve as the first point of contact from the debt settlement agency to the client. The credit specialist 310 may use any number of means to communicate with the client including phone, email, web-based forms, and regular mail. The credit specialist 310 serves in once capacity to provide the detailed information corresponding to a particular client to the contracts department 312. Such information may include, but is not limited to, the contact information for the client, debt amounts, and creditor contact information.

The contract department 312 may develop the contract between the debt settlement agency and the client. A fee may be established or negotiated between the client and the debt settlement agency. The fee could be a flat fee or could be a fee based on percentage of debt or percentage of reduced debt. The present disclosure is not meant to be limited to any particular fee structure between the client and the debt settlement agency.

An accounting department 314 may also be provided that reviews the contract, fee, and any payment schedule. The accounting department may also report to a client services department 316 and a creditor relations department 318. The client services department 316 may be responsible for keeping in contact with the client as well as informing the client of developments with the client's account, such as reaching a settlement agreement with one or more creditors. The creditor relations department 318 may provide a similar service for creditors. The creditor relations department 318 also serves as a contact point for creditors seeking additional information concerning the relationship between the debt settlement agency and client or for creditors providing settlement offers, counter offers, or acceptance.

The creditor relations department 318 may have overlapping responsibilities with the settlement department 320. The settlement department 320 may have sole or partial responsibility for negotiating with creditors. Typically, employees of the debt settlement agency working in the settlement department 320 and/or creditor relations department 318 will have experience or training in negotiating with creditors on behalf of clients. Furthermore, the debt settlement agency may be a large organization with an established business reputation. In many instances, the debt settlement agency will be able to negotiate a much better settlement with a creditor than a client could typically achieve on his or her own.

The client services department 316, the creditor relations department 318, and the settlement department 320 may also each work with a support services department 322. The support services department 322 may provide whatever services are not routinely handled by the client services department 316, the creditor relations department 318, and/or the settlement department 320. For example, litigation or retention services may be provided by the support services department 322. Specialized agents may work within the support services department such as agents trained for client retention and satisfaction. Cases may be referred to the support services department 322 by the client services department 316, the creditor relations department 318, or the settlement department 320. The support services department 322 may also employ outside agents such as attorneys in the event that litigation becomes necessary.

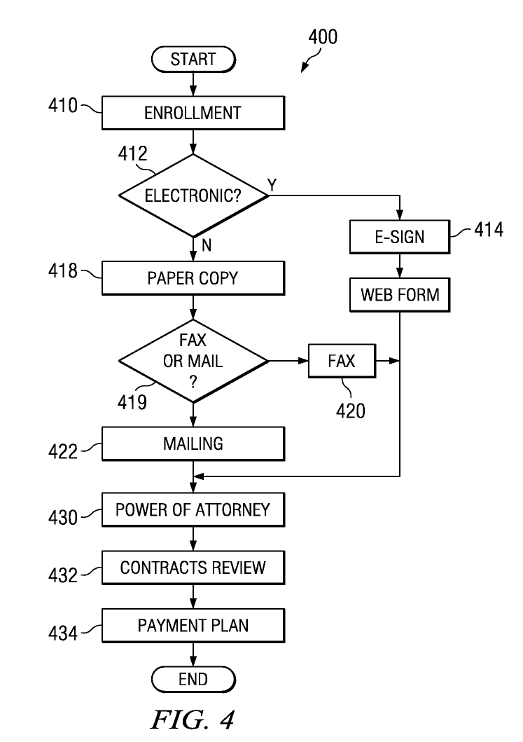

Referring now to FIG. 4, a flow diagram 400 illustrating one embodiment of a method of processing client contacts according to aspects of the present disclosure is shown. The flow diagram 400 corresponds to one method of handling a new client contact by the debt settlement agency. The enrollment of the new client begins at the enrollment step 410. A client or potential client may initially make contact with the debt settlement agency via a number of methods. The client may submit an on-line application through a web site or may contact the debt settlement agency by phone, for example. A credit specialist may contact the potential client to obtain any additional information that may be needed, such as up-to-date credit account information and balances.

Following the initial enrollment at step 410 and the gathering of the required information, there may be multiple ways to formally engage the potential client as an actual client. Two such ways are illustrated in FIG. 4. At step 412 a decision may be made regarding whether the new client will execute hard copies or paper copies of the agreements between the debt settlement agency and the client or whether electronic versions will be completed. If electronic documents are chosen at step 412, at step 414 the client may receive the documents electronically, such as downloading them from a web-based form or receiving them through electronic mail. The actual electronic documents may be in whatever form is suitable to the client and the debt settlement agency. Examples of such electronic forms include, but are not limited to, hypertext forms, text forms, or portable document format.

Returning now back to step 412, as described, the client may have the option of receiving documents in paper or hard copy at step 418. If this method is chosen, at step 419, the client may also decide to receive the documents via fax at step 420 or U.S. mail at step 422.

In some embodiments, regardless of whether a client chooses hard copy documentation or electronic documentation at step 412, a power of attorney document may be required to be submitted in hard copy at step 430. This may be done by U.S. mail or a private delivery service, for example. At step 432, the newly received contracts and powers of attorney received either in hard copy or electronically may be reviewed by the debt settlement agency. At step 434 a payment plan may be established for the client for use of the services of the debt settlement agency. It can be seen from FIG. 4 that the process of enrolling a new client into the services of the debt settlement agency may be accomplished by a combination of electronic or Internet based means and traditional paper based forms.

Referring now to FIG. 5, a flow diagram 500 illustrating one embodiment of an incoming communications process for a debt settlement agency according to aspects of the present disclosure is shown. The diagram 500 of FIG. 5 corresponds to one embodiment of a communications flow occurring within the debt settlement agency when a communication is received from either a client, a creditor, or a third party collection agency. Step 510 corresponds to an incoming communication or correspondence from a client. The client contact may be a telephone call, e-mail, fax or a traditional mailing.

In one embodiment, the client contact will be handled by a client services department, such as the client services department 316 as described with respect to FIG. 3. The client services department at step 512 may be charged with emailing or otherwise contacting the customer to confirm receipt of the client contact or correspondence. The client services department may then forward the client communication to the appropriate department within the debt settlement agency. As can be seen from FIG. 5, the client services department may forward the client communication to the accounting department at step 514, the support services department at step 516 or the settlement department at step 520. The accounting department at step 514 may receive such items as checks or drafts, updated account information or other financial data or instruments from the client. The support services department at step 516 may receive communications from the client relating to client retention, such as request for cancellation, refunds and the like. The support services department at step 516 may also be forwarded litigation and threats of legal action being brought against the client. The settlement department 520 may receive any correspondence or communications from the client concerning the settlement process with the creditors.

It may be seen from FIG. 5 that communications from creditors may be taken at step 518. Such communications may once again be telephone calls, emails, faxes or traditional communications sent through the mail. The creditor relations department at step 519 receives the communications from the creditors. These may include settlement offers, rejections, counter offers, inquiries, etc. The creditor relationship department 519 may also be charged with forwarding copies of cease and desist letters or powers of attorney received from the client as described regarding FIG. 3. In the embodiment shown, the creditor relations department at step 519 may also be charged with contacting a creditor who may be harassing a client. Mechanisms may be provided within the work flow for the client services department at step 512 to report creditor harassment claims to the creditor relations department at step 519 as shown at step 525.

The creditor relations department at step 519 may also forward correspondence to the settlement department at step 520. Such items forwarded to the settlement department at step 520 may include settlement offers, counteroffers and rejections.

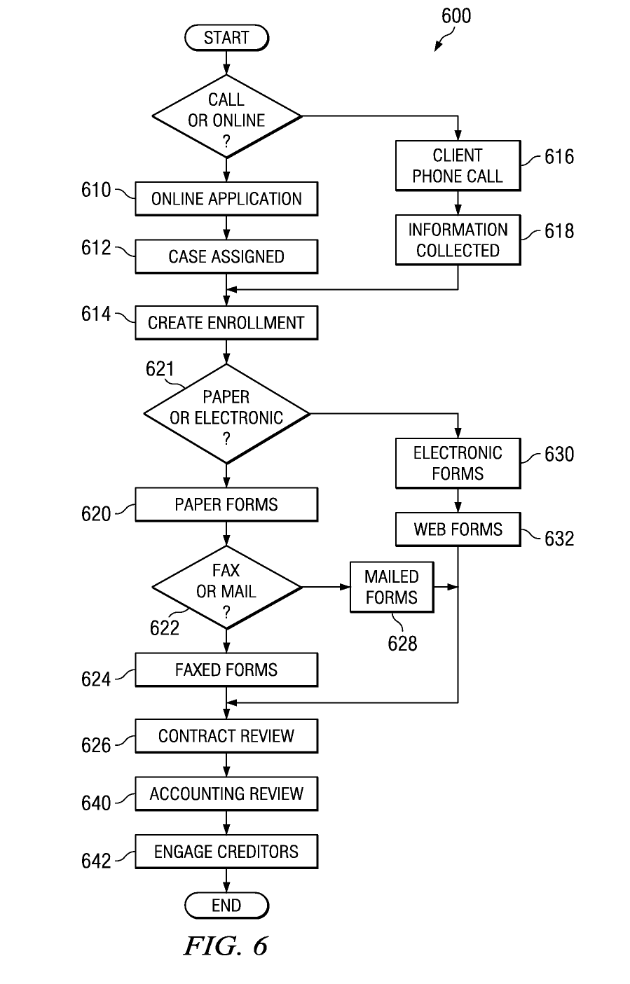

Referring now to FIG. 6, a flow diagram 600 illustrating one embodiment of a method for enrolling and servicing a debt settlement client according to aspects to the present disclosure is shown. The flow diagram 600 corresponds to one embodiment of servicing a debt settlement client from the initial client contact through the beginning of the settlement process. At step 610 a potential client submits an on-line application. In reference back to FIG. 2, this step corresponds to the client or customer 102 using a personal computer 204 to receive a web-based form from the web server 222 over the Internet 220. At step 610 the client visits the web site provided by the web server 222 and submits an on-line application. The application may include basic information such as client contact information, debt amounts, and account information. This information may be captured and stored in the relational database 230 as shown in FIG. 2. At step 612 the client contact information will be distributed to a credit specialist. The credit specialist may make follow-up phone calls or emails to the client at step 612 to ensure that all of the necessary information has been obtained. At step 614 the credit specialist creates an enrollment packet for the new client. The enrollment packet may be generated electronically. The credit specialist may use the employee work station terminal 224 as shown in FIG. 2. The credit specialist may also provide the new client with a user name and/or password for updating via a webpage or website any additional information that may be needed for storage in the relational database 230.

The work flow illustrated in FIG. 6 also allows for a new client to be obtained without necessarily resorting to the use of a personal computer or the Internet. At step 616 a potential client calls an 800 number associated with the debt settlement agency. Referring back to FIG. 2, this may correspond to the client 102 using a telephone 208 through the public switched telephone network 210 and contacting a call center 212 in order to reach a credit specialist. At step 618 the credit specialist obtains all of the needed information from the new client and inputs the information into the relational database 230 via the work station 224. It is understood that all of the information obtained by the credit specialist at step 618 will not necessarily take place over a single call, but rather may require multiple phone calls, or possibly interacting through the mail or by other means. In some embodiments it may also be possible that a client will contact the debt settlement agency via telephone at step 618, but may choose to provide some of the information electronically, such as through the Internet or by email. As before, the credit specialist will then proceed to create an enrollment packet at step 614.

Regardless of whether the new client contact comes through the Internet 220 or via the telephone 208, the credit specialist will have the option of providing the enrollment packet to the new client as a hard copy or paper copy at step 620, or electronically at step 630. In some embodiments the client will be allowed to choose whether to receive a paper copy or electronic copy of the original enrollment documents. This decision may be made at step 621. In the event the client chooses to receive a hard copy or paper copy at step 620, the documentation may be faxed or mailed or delivered via a courier to the client. The present disclosure provides a flexible system, and in some embodiments, although the client has chosen to continue the process via traditional paper method, the copies could be delivered electronically and then printed by the client at step 620. In the event that the client chooses to proceed electronically at step 630, the client may log in to the computer system of the debt settlement agency via the Internet 220 and web server 222 in order to retrieve the completed documents. At this step the client may provide any additional information directly onto the form generated by the credit specialist and may print copies of any forms or documents for the personal records of the client.

If the client chose at step 620 to use traditional paper-based forms, the enrollment packet containing the contracts and other agreements between the client and the debt settlement agency must either be executed and faxed back to the debt settlement agency at step 624 or mailed back at step 628. This may again be the customer's option to be chosen at step 622. If the client chose the electronic version of the process at step 630, at step 632 the required forms will be executed and submitted by the client electronically. In the event that the client chooses to execute the documents electronically, an electronic signature may be captured and used in place of a traditional handwritten signature.

Following completion of the forms and enrollment packet by fax at step 624, by mail at step 628, or electronically at step 632, the documents are gathered into the contracts phase at step 626. Here the contracts department receives and reviews all of the created and executed forms as well as reviews the forms for accuracy. The contracts department may also make sure that the information received on the executed forms from the client matches the information contained in the relational database 230 as shown in FIG. 2. At step 640 the accounting department may perform a similar review of the contracts. In some embodiments the accounting department will schedule a return contact through client services to the newly engaged client. Following step 640, the new client is fully engaged and prepared to utilize the services of the debt settlement agency.

At step 642 the debt settlement agency proceeds to engage the creditors on behalf of the client. At this step the creditors may each be contacted, possibly by the creditor relations department 318 as shown in FIG. 3. The creditors may be provided copies of relevant documents that have been executed by the client. Such documents may include, but are not limited to, the power of attorney and other authorization documents provided by the client to the debt settlement agency. The debt settlement agency will proceed to act on behalf of the client to negotiate a settlement or reduced payment amount corresponding to the particular debts provided to the debt settlement agency from the client.

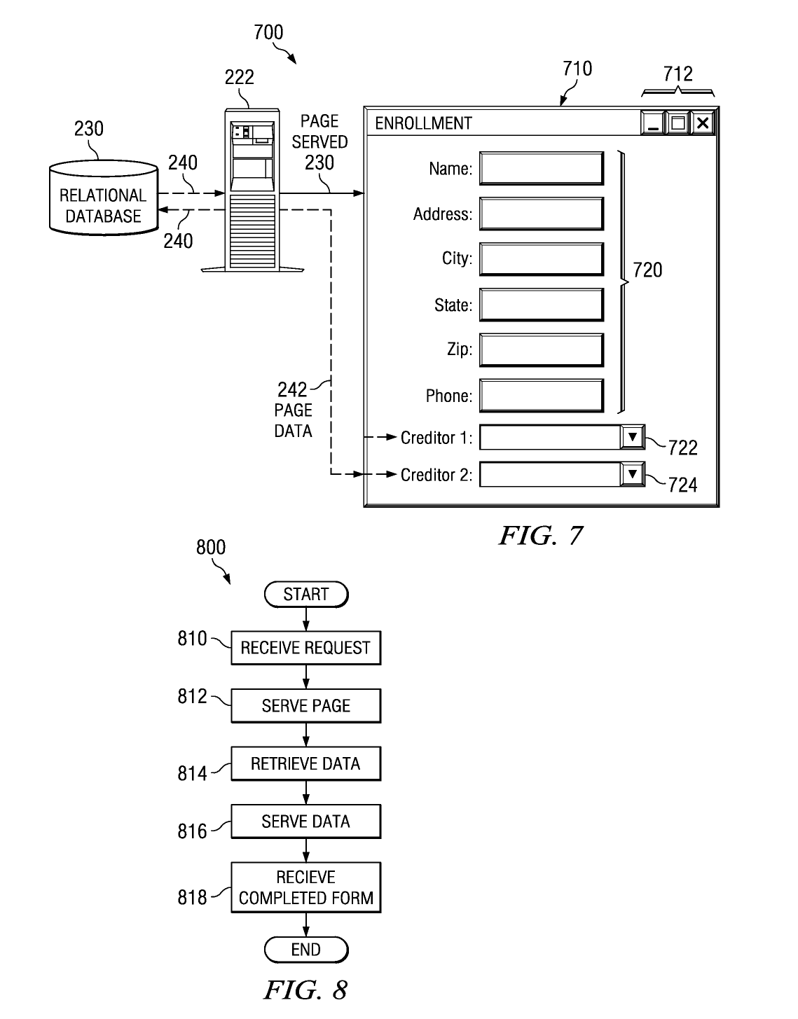

Referring now to FIG. 7, a system diagram 700 illustrating one embodiment of a web server providing an enrollment page according to aspects of the present disclosure is shown. The system 700 corresponds to one method in which the relational database 230 and the web server 222, discussed in reference to FIG. 2, may be used to serve a webpage that may be used for enrollment of clients or for other purposes by the debt settlement agency or other entities. The browser page 710 served by the web server 222 may be displayed on any compatible (e.g., modern) web browser. Typical control functions for the browser window or page 710 may be provided by buttons 712 that may be selected or clicked via a mouse as is known in the art. The particular webpage 710 is exemplary only. The webpage 710 may be used to provide an enrollment or other form and may have fields 720 for typical contact or demographic information such as address, phone number, email address, etc. The webpage 710 may also provide one or more fields 722, 724 with drop-down menus. Typically, a drop-down menu will be used in a webpage or form where there is a predetermined set of possible answer or values for the field 722, 724 or where it is important that a value be entered in a precise way. In the present context, one such example of this would be where a creditor name is being entered by a customer or credit specialist. There may be many creditors with similar or otherwise confusing names. Thus, it may be important that only an exact match to the creditor name be entered.

A large number of creditor names may be stored in the database 230. Populating a drop-down menu with such a large data set may take more time than a user is accustomed to in dealing with a webpage. In FIG. 7 it can be seen that the page is served (arrow 230) separately from the data for the drop-down menus (step 242). With the system of FIG. 7, the requested webpage can be served to the client or credit specialist immediately. The data can then be provided for the drop-down menus for the fields 722, 724 while the remainder of the form (e.g., fields 720) is being populated.

Referring now to FIG. 8 a flow diagram 800 corresponding to one method of presenting a webpage according to aspects of the present disclosure is shown. The flow diagram 800 corresponds to one method of operation of the system 700 of FIG. 7. At step 810 a request for a webpage, possibly providing an enrollment form, application form, or other form where information will be provided back to the debt settlement agency, is requested. At step 812 the page is served back to the requesting computer. At step 814, the web server retrieves the data to populate the drop-down menus from the relational database. At step 816 the data is provided into the served webpage. Although a large amount of data may be passed in steps 814 and 816, the time taken by the client or credit specialize in populating the fields not requiring drop-down menus offsets the delay in loading the data. At step 818 the customer data or other data entered on the served webpage is retrieved for use by the debt settlement agency. In some embodiments, at least part of this data will then be stored back in the relational database.

It will be appreciated by those skilled in the art having the benefit of this disclosure that this invention provides a computerized credit services information system. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method of processing online debt settlement engagement applications comprising:
receiving a customer contact lead;
contacting the customer to obtain application data;
preparing an online application form using the application data;
delivering the application to the customer via a web page;
delivering application form data to the customer following the application; and
accepting an electronic signature for completion of the application.

2. The method of claim 1, further comprising delivering application form data to the customer by populating a drop-down menu.

3. The method of claim 1, further comprising receiving a power of attorney document from the customer.

4. The method of claim 1, further comprising engaging at least one creditor on behalf of the customer in an attempt to negotiate a settlement of at least one debt.

5. The method of claim 4, further comprising updating the customer regarding the progress of the settlement negotiation.

6. The method of claim 5, further comprising updating the customer regarding the progress of the settlement negotiation electronically.

7. A method of processing online applications comprising:
serving a customer a webpage including an application form including at least one drop-down menu;
supplying data for the at least one drop down menu after serving the webpage
receiving the completed application form including an electronic signature;
storing the completed application contents in a database;
preparing an enrollment packet based upon the completed application contents;
providing the enrollment packet to the customer.

8. The method of claim 1, wherein the at least one drop down menu includes a list of known creditors.

9. The method of claim 7, further comprising receiving a completed enrollment packet from the customer.

10. The method of claim 9, further comprising receiving a completed enrollment packet from the customer by electronic means.

11. The method of claim 7, wherein providing the enrollment packet to the customer comprises providing the customer a portable document format (PDF) document containing the enrollment packet.

12. The method of claim 7, wherein the electronic signature is received via a webpage.

13. The method of claim 7, further comprising engaging at least one creditor on behalf of the customer in an attempt to negotiate a settlement of at least one debt.

14. The method of claim 13, further comprising updating the customer regarding the progress of the settlement negotiation via a webpage.

15. A system for receiving and processing online applications comprising:
a relational database adapted to retain customer and creditor contact information and credit account information;
a web server adapted to receive customer information and store the information in the relational database; and
an Internet connection for communicating with a customer computer for receiving the customer information;
wherein the web server provides an enrollment webpage to a customer based upon a predetermined format, allowing the customer to provide customer data and credit account information to the web server;
wherein the web server is configured to accept an electronic signature from the customer for the establishment of a representative relationship between the customer and a debt settlement agency.

16. The system of claim 15, wherein the web server first provides the enrollment webpage to the customer followed by at least one pick list populated based upon the creditor contact information stored in the relational database.

17. The system of claim 15, further comprising a workstation interfaced to the web server and the relational database.

18. The system of claim 17, wherein the workstation provides an interface to an employee allowing the employee to complete at least part of an online application on behalf of a customer.

19. The system of claim 18, further comprising a phone center for accepting customer information over the phone.

20. The system of claim 18, further comprising a fax center for accepting customer information via fax.
